(19) United States
(12) Patent Application Publication
(10) Pub. No.: US 2016/0337551 A1
(43) Pub. Date: Nov. 17, 2016

(54) SYSTEMS AND METHODS FOR INJECTING DOCUMENTS FROM A MOBILE DEVICE INTO A BUILD JOB FOR A MULTIFUNCTION DEVICE

(71) Applicant: Xerox Corporation, NORWALK, CT (US)

(72) Inventor: Christopher J. Daughton, Penfield, NY (US)

(21) Appl. No.: 14/711,822

(22) Filed: May 14, 2015

(51) Int. Cl. H04N 1/387; H04N 1/32; H04N 1/00

(52) U.S. Cl. CPC H04N 1/3876; H04N 1/00217; H04N 1/0022; H04N 1/00212; H04N 1/00482; H04N 1/32512; H04N 2201/0094

(57) ABSTRACT

Systems and methods for injecting documents from a mobile device into a build job on a multifunction device. A portable computing device is operatively connected to a multifunction device. Scan sources for building a job on the multifunction device are identified, using the multifunction device. The scan sources comprise a scanner function of the multifunction device and the portable computing device. A first job segment is entered and programmed on the multifunction device using one of the scan sources. A next job segment is prompted for, using the multifunction device, after the first job segment is programmed. The next job segment is obtained from one of the scan sources, using the multifunction device. The next job segment is added to an existing job comprising the first job segment. A final document for the job is assembled. The job is ended and output from the multifunction device.

### BACKGROUND

Systems and methods herein generally relate to multifunction machines having print engines and scanners and, more particularly, to combining multiple job segments from a local scanner and from a mobile device.

When a scanner is employed to generate a job, image bearing documents are scanned so that the images thereon are converted to image data for use in making prints or for transmission over a network. If a user wishes to combine images or other documents stored on a mobile device with hard copy documents scanned into a multifunction device, the user must first print those documents, manually collate them, and manually insert them in the desired locations within a stack of hard copy originals. Finally, the full stack of hard copy sheets can be scanned in at the multifunction device. The need to initially print the documents from the mobile device, and then arrange them with other hard copy sheets wastes resources and time and causes unnecessary degradation of the images from the mobile device.

Alternatively, the user could make scans of all the hard copy documents, transfer all the images (both those scanned by the multifunction device and those stored on the mobile device) to one location where the user could import the images into a single document, manipulate the images in the document, and then ftp/email/fax/print the document. In this case, image quality and resources would be preserved, but it would require multiple steps.

### SUMMARY

In one aspect of a method disclosed herein, a portable computing device, such as a mobile device, is used as a secondary document image source for the assembly of documents on a multifunction device. Some documents may be obtained by scanning into the multifunction device and some documents may be obtained from network sources. After the document is built on the multifunction device, the multifunction device would subsequently output the assembled document to one of its available output methods (print, fax, email, file-server, etc.).

Systems and methods herein eliminate the need for the user to first print and collate the mobile device's documents. As disclosed herein, a user can automatically transmit documents from a mobile device to a multifunction device and insert those documents into any job that requires use of the multifunction device's scanner (e.g., copy, network scan, fax). The mobile device would function as an alternate scan source for the multifunction device. That is, when programming any scan-related job (or any scan segment, if the job is a “build job” consisting of multiple separately scanned documents), a list of available document sources is presented to the user. The list of sources includes the multifunction device's inherent scanner as well as a mobile devices carried by the user. The method disclosed herein eliminates the need for the user to first print and collate the mobile device's documents, saving resources and time as well as preserving the image quality of those documents.

According to a method herein, first document images are entered into a multifunction device using a first scan source. The first scan source comprises one of a scanner associated with the multifunction device and a portable computing device. The portable computing device is wirelessly connected to the multifunction device. The first document images are added to a job. Second document images are identified for adding to the job using a second scan source. The second scan source comprises one of the scanner associated with the multifunction device and the portable computing device. The second document images are added to the job. A final document is assembled using the multifunction device. The final document comprises the first document images and the second document images. A job ticket is produced, with the multifunction device, for the job. The job ticket comprises the final document. The job is output from the multifunction device.

According to another method herein, a portable computing device is operatively connected to a multifunction device. Scan sources for building a job on the multifunction device are identified, using the multifunction device. The scan sources comprise a scanner function of the multifunction device and the portable computing device. A first job segment is entered and programmed on the multifunction device using one of the scan sources. A next job segment is prompted for, using the multifunction device, after the first job segment is programmed. The next job segment is obtained from one of the scan sources, using the multifunction device. The next job segment from the one of the scan sources is added to an existing job that comprises the first job segment. A final document is assembled for the job, using the multifunction device. The job is ended. The job is output from the multifunction device.

According to a system, a multifunction device comprises a processor. A first scan source comprising a scanner is operatively connected to the processor. A graphic user interface is operatively connected to the processor. The multifunction device includes an input/output connection comprising a wireless network connection. The system includes an application running on a portable computing device. The portable computing device is wirelessly connected to the multifunction device. The portable computing device comprises a second scan source comprising a memory storing documents. The application enables identification of a document in the memory for building a job. The processor obtains a first job segment from one of the first scan source and the second scan source. After the first job segment is obtained, the processor prompts for a next job segment, using the graphic user interface. The processor obtains the next job segment from one of the first scan source and the second scan source. The processor adds the next job segment to an existing job comprising the first job segment. The processor assembles a final document comprising first document images from the first job segment and second document images from the next job segment. The processor outputs the job from the multifunction device.

These and other features are described in, or are apparent from, the following detailed description.

### BRIEF DESCRIPTION OF THE DRAWINGS

Various examples of the systems and methods are described in detail below, with reference to the attached drawing figures, which are not necessarily drawn to scale and in which:

FIG. 1 is a side-view schematic diagram of a multifunction device according to systems and methods herein;

FIG. 2 is a block diagram illustrating a portable computing device according to systems and methods herein;

FIG. 3 is a flow diagram illustrating methods herein;

FIG. 4 functionally illustrates segment scan sources according to systems and methods herein; and

FIG. 5 is a schematic diagram illustrating systems and methods herein.

### DETAILED DESCRIPTION

The disclosure will now be described by reference to a multifunction device and a portable computing device that includes an application for identifying documents on the portable computing device. While the disclosure will be described hereinafter in connection with specific systems and methods thereof, it will be understood that limiting the disclosure to such specific systems and methods is not intended. On the contrary, it is intended to cover all alternatives, modifications, and equivalents as may be included within the spirit and scope of the disclosure as defined by the appended claims.

For a general understanding of the features of the disclosure, reference is made to the drawings. In the drawings, like reference numerals have been used throughout to identify identical elements.

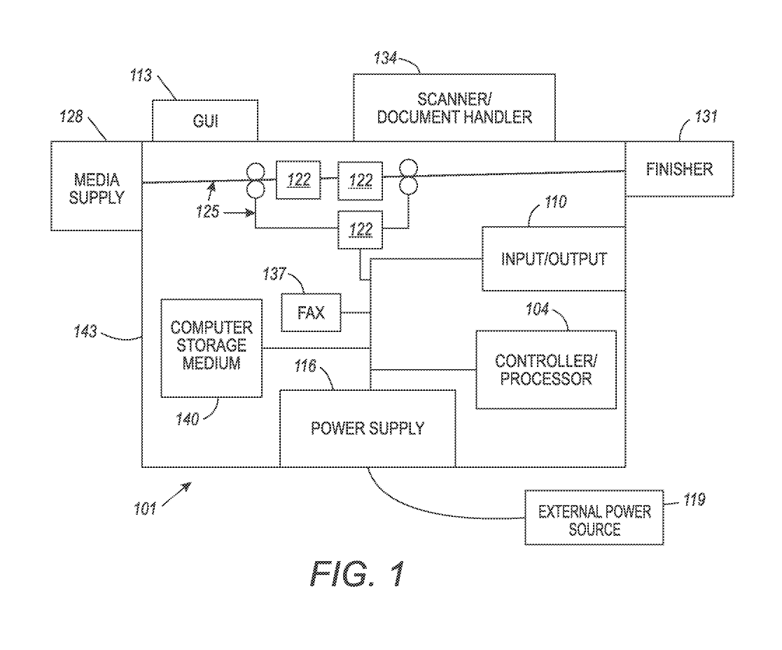

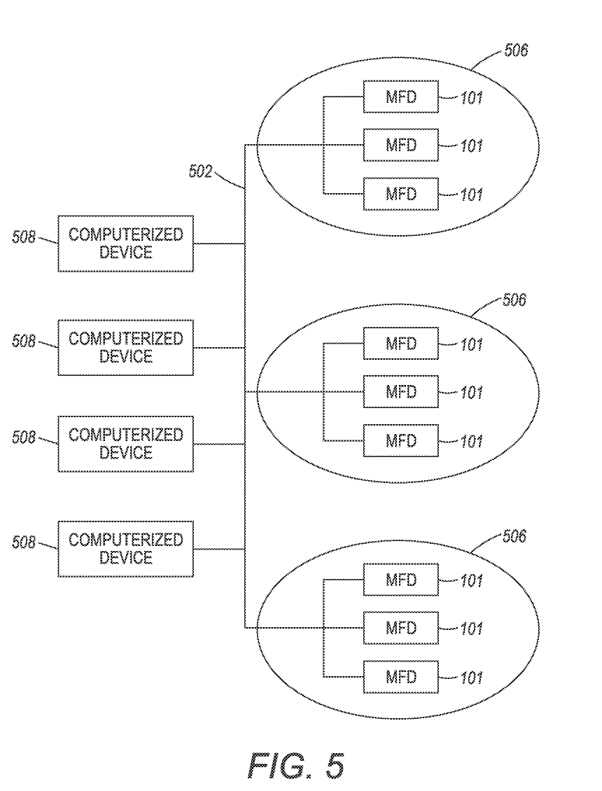

FIG. 1 illustrates a multifunction device 101 that can be used with systems and methods herein and can comprise, for example, a printer, a copier, a fax machine, etc. The multifunction device 101 includes a controller/processor 104 and an input/output device 110 operatively connected to the controller/processor 104. The controller/processor 104 may be connected to a computerized network 502 external to the multifunction device 101 through a communications port of the input/output device 110, such as shown in FIG. 5, described below. In addition, the multifunction device 101 can include at least one accessory functional component, such as a graphic user interface assembly (GUI) 113. The GUI 113 acts as common interface for job submission and operates on power supplied from a power supply 116. An external power source 119 may provide electrical power to the multifunction device 101 through the power supply 116. The input/output device 110 is used for communications to and from the multifunction device 101. The controller/processor 104 controls the various actions of the multifunction device 101.

The multifunction device 101 may include at least one marking device 122 (sometimes referred to as printing engines) operatively connected to the controller/processor 104. A media path 125 is positioned to supply sheets of media from a media supply 128 to the marking device(s) 122, etc., along the media path 125. After receiving various markings from the printing engine(s), the sheets of media can optionally pass to a finisher 131 which can fold, staple, sort, etc., the various printed sheets.

Further, the marking device 122 is any device capable of rendering an image. The set of marking devices includes digital document reproduction equipment and other copier systems as are widely known in commerce, photographic production and reproduction equipment, monitors and other displays, computer workstations and servers, including a wide variety of color marking devices, and the like.

To render an image is to reduce the image data (or a signal thereof) to viewable form; store the image data to memory or a storage device for subsequent retrieval; or communicate the image data to another device. Such communication may take the form of transmitting a digital signal of the image data over a network.

In addition, the multifunction device 101 can include at least one accessory functional component (such as a scanner/document handler 134, fax module 137, etc.) that also operates on the power supplied from the external power source 119 (through the power supply 116). The fax module 137 may operate in conjunction with the scanner/document handler 134.

The scanner/document handler 134 may be any image input device capable of obtaining information from an image. The set of image input devices is intended to encompass a wide variety of devices such as, for example, digital document devices, computer systems, memory and storage devices, networked platforms such as servers and client devices which can obtain pixel values from a source device, and image capture devices. The set of image capture devices includes scanners, cameras, photography equipment, facsimile machines, photo reproduction equipment, digital printing presses, xerographic devices, and the like. A scanner is one image capture device that optically scans images, print media, and the like, and converts the scanned image into a digitized format. Common scanning devices include variations of the flatbed scanner, generally known in the art, wherein specialized image receptors move beneath a platen and scan the media placed on the platen. Modern digital scanners typically incorporate a charge-coupled device (CCD) or a contact image sensor (CIS) as the image sensing receptor(s). The scanning device produces a signal of the scanned image data. Such a digital signal contains information about pixels such as color value, intensity, and their location within the scanned image.

The multifunction device 101 may also include a non-transitory computer storage medium 140 (which can be optical, magnetic, capacitor based, etc.) is readable by the controller/processor 104 and stores instructions that the controller/processor 104 executes to allow the multifunction device 101 to perform its various functions, such as those described herein.

According to systems and methods herein, the controller/processor 104 may comprise a special purpose processor that is specialized for processing image data and includes a dedicated processor that would not operate like a general purpose processor because the dedicated processor has application specific integrated circuits (ASICs) that are specialized for the handling of job creation operations, processing document image data, etc. In one example, the multifunction device 101 is special purpose machine that includes a specialized processing card having unique ASICs for providing document processing instructions, includes specialized boards having unique ASICs for input and output devices to speed network communications processing, a specialized ASIC processor that performs the logic of the methods described herein using dedicated unique hardware logic circuits, etc. It is contemplated that the controller/processor 104 may comprise a raster image processor (RIP). A raster image processer uses the original image description to RIP the print job. Accordingly, the build job instruction data is converted to a printer-readable language. The job description is generally used to generate a ready-to-print file. The ready-to-print file may be a compressed file that can be repeatedly accessed for multiple (and subsequent) passes.

It should be understood that the controller/processor 104 as used herein comprises a computerized device adapted to perform (i.e., programmed to perform, configured to perform, etc.) the below described system operations. According to systems and methods herein, the controller/processor 104 comprises a programmable, self-contained, dedicated mini-computer. The details of such computerized devices are not discussed herein for purposes of brevity and reader focus.

Thus, as shown in FIG. 1, a device housing 143 has one or more functional components that operate on power supplied from the external power source 119, which may comprise an alternating current (AC) power source, through the power supply 116. The power supply 116 can comprise a power storage element (e.g., a battery) and connects to the external power source 119. The power supply 116 converts the external power into the type of power needed by the various components of the multifunction device 101.

As would be understood by those ordinarily skilled in the art, the multifunction device 101 shown in FIG. 1 is only one example and the systems and methods herein are equally applicable to other types of document handling devices that may include fewer components or more components. For example, while a limited number of printing engines and paper paths are illustrated in FIG. 1, those ordinarily skilled in the art would understand that many more paper paths and additional printing engines could be included within any printing device used with systems and methods herein.

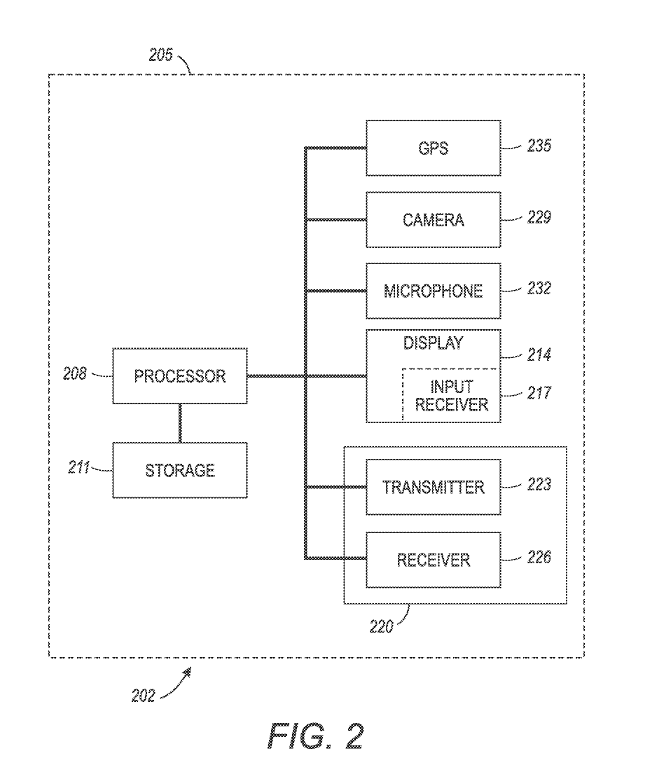

FIG. 2 shows a block diagram of a portable computing device 202 according to systems and methods herein. The portable computing device 202 contains several components enclosed in a housing 205. The housing 205 contains a processor 208 operatively connected to a storage device 211. The storage device 211 has program code embodied therewith, which program code is readable and executable by the processor 208, as described in further detail below.

It should be understood that the processor 208 as used herein comprises a computerized device adapted to perform (i.e., programmed to perform, configured to perform, etc.) the below described system operations. According to systems and methods herein, the processor 208 comprises a programmable, self-contained, dedicated mini-computer. The details of such computerized devices are not discussed herein for purposes of brevity and reader focus.

The portable computing device 202 includes a display device 214 that can provide a user interface (UI) and can function as the main control interface for the portable computing device 202. The display device 214 may be a graphic user interface comprising a touch-enabled screen, which will be the main go-to point for user interaction with the portable computing device 202. The display device 214 should be appropriately sized for the portable computing device, which may comprise a mobile phone, such as smartphone, a laptop computer, a notebook computer, a tablet device, or any other appropriate device now known or developed in the future.

The display device 214 may include an input receiver 217 operatively connected to the processor 208. The input receiver 217 receives selection of a selected application to be performed by the processor 208. For example, a user may search for and choose a document by selecting an appropriate icon on the display device 214, as described in further detail below. A user may select a document to add to a job using the input receiver 217 of the display device 214.

As shown in FIG. 2, the portable computing device 202 further includes an input/output connection, such as communications device 220 having a transmitter 223 and a receiver 226. The transmitter 223 is operatively connected to the processor 208. The transmitter 223 transmits electromagnetic signals to a recipient, such as transmitting a document to the multifunction device 101. The receiver 226 is operatively connected to the processor 208. The receiver 226 receives electromagnetic signals into the portable computing device 202. The communications device 220 may be capable of a variety of communication techniques using wired or wireless technology.

A camera 229 or other image acquisition device operatively connected to the processor 208 may also be included in the portable computing device 202. Additionally, the portable computing device 202 may include a phone application 232, a GPS application 235, etc., which may be operatively connected to the processor 208.

According to systems and methods herein, the portable computing device 202 may comprise a mobile phone, such as a smartphone, a laptop computer, a notebook computer, a computer tablet, or any other appropriate device now known or developed in the future. Smartphones, laptop computers, notebook computers, and tablet devices commonly include input/output devices, power supplies, processors, electronic storage memories, wiring, etc., the details of which are omitted herefrom to allow the reader to focus on the salient aspects of the systems and methods described herein.

Multifunctional devices, such as shown in FIG. 1, are typically full featured. Various ones of the features provide one or more functions to be performed on a job. For example, a job may include capturing an image at the image input section for storage. The image may undergo a significant amount of image processing allowing for the minimization of image related artifacts and various electronic pages may be edited after the job has been suitably stored. After outputting of the stored job, a host of finishing operations, such as stapling, folding, and trimming may be performed on the hardcopy version of the job to optimize its appearance.

In view of the complexity of a given job, it may be desirable to “build” a job on a segment-by-segment basis. Various parts of the job are created separately for each segment and then merged to append various contents to the job as it is being scanned into the system. That is, any number of additional documents or groups of documents may be scanned in with the job currently being scanned. In the present disclosure, the mobile device is used as a document scan source for one or more segments. Once all the desired segments are added, an END JOB icon is selected, and the job is stored in a memory section for further processing. The process is described below by way of example.

A user may have stored one or more electronic documents on a mobile device, sometimes referred to herein as a portable computing device 202. The documents may include photographs taken with the camera 229 of the portable computing device 202. In this example, the documents and/or photographs will be used to put together a report to be emailed. In addition, the user has hard copies of other documents that will be included in the same report. The user structures the report such that it begins with one of the hard copy documents followed by one of the electronic documents from the mobile device, another hard copy document, and, finally, photographs from the mobile device.

Carrying the mobile device with the electronic documents, the user approaches a multifunction device 101 and programs the machine for a scan-to-email “build job” (i.e., a job consisting of multiple separate scan segments that are combined within a single job). The multifunction device 101 automatically detects the portable computing device 202 and populates a scan source list, which is presented on the GUI 113. The scanner/document handler 134 of the multifunction device 101 and the portable computing device 202 appear as selections in the scan source list.

The user, having already selected “build job”, chooses the scanner/document handler 134 as the selected scan source for the first scan segment. The user loads the appropriate document into the document handler and hits <Start>. The multifunction device 101 begins scanning the sheets in the scanner/document handler 134. Once all the sheets have been scanned, the multifunction device 101 prompts the user to either input a second scan segment or close out input and start processing the job.

In this example, the user elects to create a new scan segment and chooses the portable computing device 202 as the selected scan source. The user identifies the appropriate document using either the GUI 113 on the multifunction device 101 or the display device 214 on the portable computing device 202. When the user hits the <Start> button, the selected document is automatically transferred from the mobile device to the multifunction device 101, with all constituent images injected into the build job just as if they had been scanned on the multifunction device 101. Once the entire document has been transferred, the multifunction device 101 again prompts the user to either input a third scan segment or close out input and start processing the job.

In this example, the user elects to create another new scan segment and chooses the scanner/document handler 134 of the multifunction device 101 as the selected scan source for the new scan segment. Again, the user loads the appropriate document into the document handler and hits <Start>. The multifunction device 101 again scans the sheets in the scanner/document handler 134. Once all the sheets have been scanned, the multifunction device 101 prompts the user to either input a fourth scan segment or close out input and start processing the job.

The user once more elects to create a new scan segment and chooses the portable computing device 202 as the selected scan source. In this step of the example, the user selects all the desired photographs, in the desired order using either the GUI 113 on the multifunction device 101 or the display device 214 on the portable computing device 202. When the user hits the <Start> button, the selected photographs are automatically transferred from the mobile device to the multifunction device 101 in the selected order. In this example, each photograph is injected into the build job just as if it had been scanned on the multifunction device 101. Once all the photographs have been transferred, the multifunction device 101 prompts the user to either input a fifth scan segment or close out input and start processing the job.

The user finally elects to close out input and start processing the job. According to this example, the multifunction device 101 then emails the job to all selected recipients. The user leaves the machine, having done no more work than the user would have done for a “normal” build job.

While the above example describes four scan segments beginning with a hardcopy scan on the multifunction device 101, followed by scan segment from the portable computing device 202, etc., one of ordinary skill in the art would recognize that the systems and methods described herein should neither be limited by the number of documents (or segments) nor by any kind of ordering. For example, it is contemplated that the first document (segment) could be an MSWord document from the mobile device, each of documents (segments) 2-28 could be separate scans on the multifunction device 101, documents (segments) 29-42 could be separate documents from the mobile device, document (segment) 43 could be a scan on the multifunction device 101, etc. Accordingly, the claims should be interpreted as allowing various scan sources for a variety of segments in order to build a job on the multifunction device 101.

Furthermore, while the above example describes outputting the job by email, one of ordinary skill in the art would recognize that the multifunction device 101 may support many output types, such as sending output by fax, sending output by internet fax, sending output by network transfer, sending output by email, storing output on a portable storage device (e.g., USB drive), and printing. It is contemplated that the output may comprise any technique now known or developed in the future.

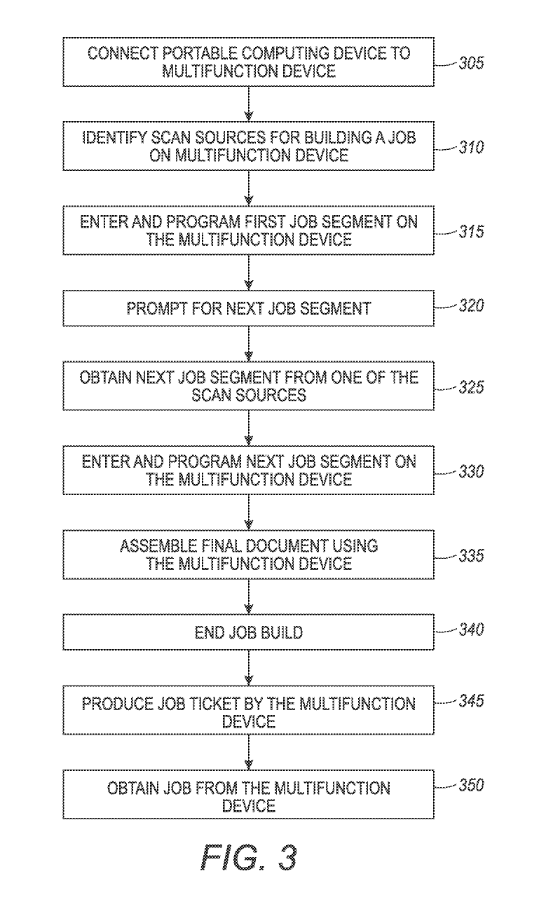

FIG. 3 is a flow diagram illustrating the processing flow of an exemplary method according to systems and methods herein. At 313, a portable computing device is operatively connected to a multifunction device. According to systems and methods herein, the portable computing device may be wirelessly connected to the multifunction device. At 319, scan sources for building a job on the multifunction device are identified, using the multifunction device. The scan sources comprise a scanner function of the multifunction device and the portable computing device. At 325, a first job segment is entered and programmed on the multifunction device. In this step, first document images may be entered into the multifunction device, using one of the scan sources. The first document images are then added to the job. At 331, a next job segment is prompted for, using the multifunction device, after the first job segment is programmed. At 337, the next job segment is obtained from one of the scan sources, using the multifunction device. In this step, second document images are identified for adding to the job. At 343, the next job segment comprising the second document images is added and programmed on the multifunction device to the existing job comprising the first job segment. At 349, the final document is assembled using the multifunction device. The final document comprises the first document images and the second document images. At 355, the build job is ended. At 361, a job ticket is produced by the multifunction device, for the job. The job ticket comprises the final document. At 367, the job is output from the multifunction device.

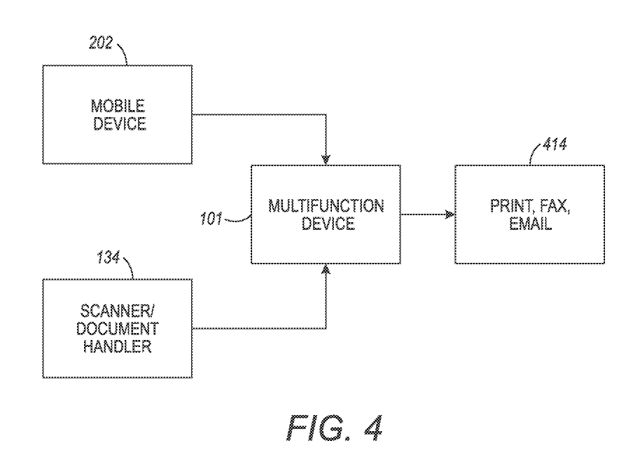

FIG. 4 functionally illustrates the relationship of the segment scan sources. The multifunction device 101 displays the available scan sources on the GUI 113. When the user approaches the multifunction device 101, the multifunction device 101 automatically detects the portable computing device 202 as a scan source list, in addition to the scanner/document handler 134. In other words, the scanner/document handler 134 of the multifunction device 101 and the portable computing device 202 appear as selections in the scan source list. After the document is built on the multifunction device 101, the multifunction device 101 can output the assembled document using one of its available output methods 414 (print, fax, internet fax, email, network transfer, USB drive, file-server, etc.).

As shown in FIG. 5, exemplary printers, copiers, multifunction machines, and multifunction devices (MFD) 101 may be located at various different physical locations 506. Other devices according to systems and methods herein may include various computerized devices 508. The computerized devices 508 can include print servers, printing devices, personal computers, etc., and are in communication (operatively connected to one another) by way of a network 502. The network 502 may be any type of network, including a local area network (LAN), a wide area network (WAN), or a global computer network, such as the Internet.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, it is not intended for the claims presented below to be limited by the attached drawings, but instead the attached drawings are merely provided to illustrate a few ways in which the claimed features can be implemented.

The hardware described herein plays a significant part in permitting the foregoing method to be performed, rather than function solely as a mechanism for permitting a solution to be achieved more quickly, (i.e., through the utilization of a computer for performing analysis and calculations). For example, these methods allow a mobile user to create many types of documents from multiple sources without requiring that documents or photographs on the mobile device be separately printed and scanned. Therefore, such processes as transferring a document from the mobile device to the multifunction device, creating individual scan segments, and building a final document for further output require the use of a computerized processor to both access the document and to process the document.

As would be understood by one ordinarily skilled in the art, the processes described herein cannot be performed by human alone (or one operating with a pen and a pad of paper) and instead such processes can only be performed by a machine. Specifically, processes such as scanning, printing, building a document, creating print tickets, etc., require the utilization of different specialized machines. Therefore, for example, the production of a multiple scan segments, transferring document images from the portable computing device to the multifunction device, and building the document, which are performed by the devices herein, cannot be performed manually (because machines are required to perform document processing) and such devices are integral with the processes performed by methods herein. Further, such machine-only processes are not mere “post-solution activity” because the automated scan and build of each document is integral with the steps of the processes described herein. Similarly, the scanning and transfer of data require special purpose equipment (telecommunications equipment, routers, switches, etc.) that is distinct from a general-purpose processor. In other words, these various machines are integral with the methods herein because the methods cannot be performed without the machines (and cannot be performed by humans alone).

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods, and computer program products according to various systems and methods herein. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock, Tex., USA and Apple Computer Co., Cupertino, Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multifunction machine, etc., which performs a print outputting function for any purpose. The details of printers, printing engines, etc., are well known by those ordinarily skilled in the art and are not described in detail herein to keep this disclosure focused on the salient features presented. The systems and methods herein can encompass devices that print in color, monochrome, or handle color or monochrome image data. All foregoing systems and methods are specifically applicable to electrostatographic and/or xerographic machines and/or processes.

The terminology used herein is for the purpose of describing particular systems and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein, are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms “automated” or “automatically” mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various systems and methods of the present disclosure have been presented for purposes of illustration, but are not intended to be exhaustive or limited to the systems and methods disclosed. Many modifications and variations will be apparent to those of ordinary skill in the art without departing from the scope and spirit of the described systems and methods. The terminology used herein was chosen to best explain the principles of the systems and methods, the practical application or technical improvement over technologies found in the marketplace, or to enable others of ordinary skill in the art to understand the systems and methods disclosed herein.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. A method, comprising:
using a first scan source, entering first document images into a multifunction device, said first scan source comprising a scanner associated with said multifunction device;
adding said first document images to a job;
using a second scan source, identifying second document images for adding to said job, said second scan source comprising a portable computing device wirelessly connected to said multifunction device, said portable computing device comprising a camera obtaining document images;
adding said second document images to said job;
assembling a final document using said multifunction device, said final document comprising:
said first document images, and
said second document images;
producing, with said multifunction device, a job ticket for said job comprising said final document; and
outputting said job from said multifunction device.

2. The method according to claim 1, further comprising:
identifying a document in a memory of said portable computing device;
selecting, on said portable computing device, said document for adding to said job; and
transferring images of said document from said portable computing device to said multifunction device.

3. The method according to claim 1, said outputting said job from said multifunction device comprising one of sending said final document by fax, sending said final document by internet fax, sending said final document by network transfer, sending said final document by email, storing said final document on a portable storage device, and printing said final document.

4. The method according to claim 1, said portable computing device comprising one of a mobile phone, laptop computer, notebook computer, and a tablet.

5. The method according to claim 1, further comprising:
automatically identifying said portable computing device as a scan source for building said job.

6. The method according to claim 1, further comprising:
said multifunction device prompting for another segment of said job after each segment is entered and programmed.

7. The method according to claim 6, each segment of said job being added automatically from a selected scan source.

8. A method, comprising:
wirelessly connecting a portable computing device to a multifunction device, said portable computing device comprising a camera obtaining document images;
identifying, using said multifunction device, scan sources for building a job on said multifunction device, said scan sources comprising a scanner function of said multifunction device and said portable computing device;
entering and programming a first job segment on said multifunction device using one of said scan sources;
prompting for a next job segment after said first job segment is programmed, using said multifunction device;
obtaining said next job segment from said one of said scan sources, using said multifunction device, said one of said scan sources for said next job segment being different from said one of said scan sources for said first job segment;
adding said next job segment from said one of said scan sources to an existing job comprising said first job segment, using said multifunction device;
assembling a final document for said job, using said multifunction device;
ending said job; and
outputting said job from said multifunction device.

9. The method according to claim 8, further comprising:
entering and programming a third job segment on said multifunction device using one of said scan sources; and
adding said third job segment to said existing job comprising said first job segment and said next job segment.

10. The method according to claim 9, further comprising:
said multifunction device prompting for additional segments of said job after each segment is entered and programmed.

11. The method according to claim 10, each segment of said job being added automatically from a selected one of said scan sources.

12. The method according to claim 8, said outputting said job from said multifunction device comprising one of sending said final document by fax, sending said final document by internet fax, sending said final document by network transfer, sending said final document by email, storing said final document on a portable storage device, and printing said final document.

13. The method according to claim 8, said portable computing device comprising one of a mobile phone, laptop computer, notebook computer, and a tablet.

14. The method according to claim 8, further comprising:
automatically identifying said portable computing device as a scan source for building said job.

15. A system, comprising:
a multifunction device comprising:
a processor,
a first scan source comprising a scanner operatively connected to said processor,
a graphic user interface operatively connected to said processor, and
an input/output connection comprising a wireless network connection; and
an application running on a portable computing device, said portable computing device being wirelessly connected to said multifunction device, said portable computing device comprising a second scan source comprising a memory storing documents, and said application enabling identification of a document in said memory for building a job;
said processor obtaining a first job segment from one of said first scan source and said second scan source,
said processor prompting, using said graphic user interface, for a next job segment after said first job segment is obtained,
said processor obtaining said next job segment from one of said first scan source and said second scan source,
said processor adding said next job segment to an existing job comprising said first job segment,
said processor assembling a final document comprising:
first document images from said first job segment, and
second document images from said next job segment, and
said processor outputting said job from said multifunction device.

16. The system according to claim 15, said input/output connection operatively connecting said portable computing device to said multifunction device.

17. The system according to claim 15, said application causing said portable computing device to transfer said document in said memory from said portable computing device to said multifunction device.

18. The system according to claim 15, said application enabling identification of said portable computing device as a scan source for building said job on said multifunction device.

19. The system according to claim 15, said portable computing device comprising one of a mobile phone, laptop computer, notebook computer, and a tablet.

20. The system according to claim 15, said processor outputting said job from said multifunction device comprising one of sending said final document by fax, sending said final document by internet fax, sending said final document by network transfer, sending said final document by email, storing said final document on a portable storage device, and printing said final document.
